(19) United States
(12) Patent Application Publication
(10) Pub. No.: US 2011/0024278 A1
(43) Pub. Date: Feb. 3, 2011

(54) SUPPORTING STRUCTURE, METHOD FOR MANUFACTURING SUPPORTING STRUCTURE AND KEYBOARD

(76) Inventor: Yi-Chen Wang, Taoyuan (TW)

Correspondence Address: NORTH AMERICA INTELLECTUAL PROPERTY CORPORATION, P.O. BOX 506, MERRIFIELD, VA, 22116, US

(21) Appl. No.: 12/841,997

(22) Filed: Jul. 22, 2010

(30) Foreign Application Priority Data
Jul. 31, 2009 (TW) 098125785

(51) Int. Cl. H01H 13/76; H01H 13/02; B23P 19/04

(52) U.S. Cl. 200/5 A; 200/344; 29/428

(57) ABSTRACT

A supporting structure is used for supporting a key cap. The supporting structure includes a first supporting member and a second supporting member. A first arm of the first supporting member includes a first connecting part and a second connecting part. The first connecting part can be movably connected to the key cap. The second connecting part has a C-shaped hole. A second arm of the second supporting member includes a third connecting part and a fourth connecting part. The third connecting part can be movably connected to the key cap. The fourth connecting part has a shaft. The shaft can be embedded into the C-shaped hole via an opening of the C-shaped hole, such that the first supporting member and the second supporting member can rotate relative to each other.

### BACKGROUND OF THE INVENTION

1. Field of the Invention

The invention relates to a supporting structure and, more particularly, to a supporting structure capable of being assembled rapidly and a method for manufacturing the same. Furthermore, the supporting structure can be applied to a variety of keyswitches and keyboards.

2. Description of the Prior Art

With the development of technology recently, a keyboard is still the most common input device for a variety of data processing systems, even though a variety of input devices have been developed.

Generally speaking, a supporting structure of a conventional keyswitch of a keyboard is usually a scissor-type mechanism. That is to say, the supporting structure is constructed of at least two supporting members. One end of the two supporting members is connected to a key cap, and the other end of the two supporting members is connected to a base of the keyswitch. The two supporting members of the scissor-type mechanism are pivotally connected to each other with a shaft and a hole in the center. Therefore, the two supporting members are capable of rotating relative to each other, such that the key cap of the keyswitch is capable of moving relative to the base vertically. While assembling the supporting structure, one of the two supporting members is needed to be deformed to allow the other one to be assembled with it, such that manpower and cost will increase.

Besides, the two supporting members are formed in individual injection mold, and the two supporting members are assembled after being taken out from the individual injection mold. It is unable to assemble a plurality of supporting members at the same time. Therefore, it may need more manpower in assembling the supporting structure, such that production cost may increase.

### SUMMARY OF THE INVENTION

Therefore, an objective of the invention is to provide a supporting structure capable of being assembled easily. The supporting structure is capable of being assembled automatically and rapidly along a vertical direction or a horizontal direction after the supporting structure is formed in an injection mold, so as to solve the problems mentioned above.

According to one embodiment, a supporting structure of the invention comprises a first supporting member and a second supporting member. A first connecting part and a second connecting part are disposed at both ends of a first arm of the first supporting member respectively. The first connecting part is movably connected to a key cap. A C-shaped hole is formed on the second connecting part. A third connecting part and a fourth connecting part are disposed at both ends of a second arm of the second supporting member respectively. The third connecting part is movably connected to the key cap and opposite to the first connecting part. A shaft is disposed on the fourth connecting part. The shaft is embedded into the C-shaped hole via an opening of the C-shaped hole, such that the first supporting member and the second supporting member are capable of rotating relative to each other.

According to another embodiment, a method of the invention for manufacturing a supporting structure comprises the following steps. First of all, a first supporting member and a second supporting member are respectively formed on a first portion and a second portion of a mold with injection molding. The first supporting member has a first arm, a first connecting part and a second connecting part are disposed at both ends of the first arm respectively, the first connecting part is movably connected to a key cap, and a C-shaped hole is formed on the second connecting part . The second supporting member has a second arm, a third connecting part and a fourth connecting part are disposed at both ends of the second arm respectively, the third connecting part is movably connected to the key cap and opposite to the first connecting part, and a shaft is disposed on the fourth connecting part. The first supporting member and the second supporting member are formed in the mold correspondingly. Then, the first supporting member and the second supporting member are departed from the mold. Afterward, the shaft is embedded into the C-shaped hole, such that the first supporting member and the second supporting member are capable of rotating relative to each other, so as to complete the supporting structure. Finally, the first protruding shaft and the second protruding shaft are movably and pivotally connected to a base, such that the first arm and the second arm are capable of moving relative to the base.

According to another embodiment, a keyboard of the invention comprises a base, a plurality of keycaps and a plurality of supporting structures. The plurality of supporting structures is disposed between the key caps and the base and used for supporting the key caps. Each of the supporting structures comprises a first supporting member and a second supporting member. A first connecting part and a second connecting part are disposed at both ends of a first arm of the first supporting member respectively. The first connecting part is movably connected to the key cap. A C-shaped hole is formed on the second connecting part. A third connecting part and a fourth connecting part are disposed at both ends of a second arm of the second supporting member respectively. The third connecting part is movably connected to the key cap and opposite to the first connecting part. A shaft is disposed on the fourth connecting part. The shaft is embedded into the C-shaped hole via an opening of the C-shaped hole, such that the first supporting member and the second supporting member are capable of rotating relative to each other.

As mentioned in the above, after the supporting structure of the invention is formed in the injection mold, an operator only has to embed the shaft of one supporting member into the C-shaped hole of another supporting member via the opening of the C-shaped hole, and then takes the plurality of supporting structures out, so as to complete the supporting structure. The supporting structure of the invention can be assembled automatically due to the improved engagement of the supporting structure, so as to decrease manpower in assembling and lower production cost, such that cost for manufacturing keyswitch or keyboard can be lowered as well.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a supporting structure according to a first embodiment of the invention.

FIG. 2A to FIG. 2C are schematic diagrams illustrating different types of second connecting parts of FIG. 1.

FIG. 2D is a schematic diagram illustrating different type of fourth connecting part of FIG. 1.

FIG. 3 is a schematic diagram illustrating the supporting structure disposed on a base.

FIG. 4 is a flow chart illustrating a method for manufacturing the supporting structure according to a second embodiment of the invention.

FIG. 5 is a schematic diagram illustrating two first supporting members formed on a first portion and two second supporting members formed on a second portion.

FIG. 6A is a schematic diagram illustrating a shaft embedded into a C-shaped hole along a horizontal direction.

FIG. 6B is a schematic diagram illustrating a shaft embedded into a C-shaped hole along a vertical direction.

FIG. 7A is a sectional diagram illustrating a keyswitch according to a third embodiment of the invention.

FIG. 7B is a schematic diagram illustrating a supporting structure disposed on a base of the FIG. 7A.

FIG. 8 is a schematic diagram illustrating a keyboard according to a fourth embodiment of the invention.

### DETAILED DESCRIPTION

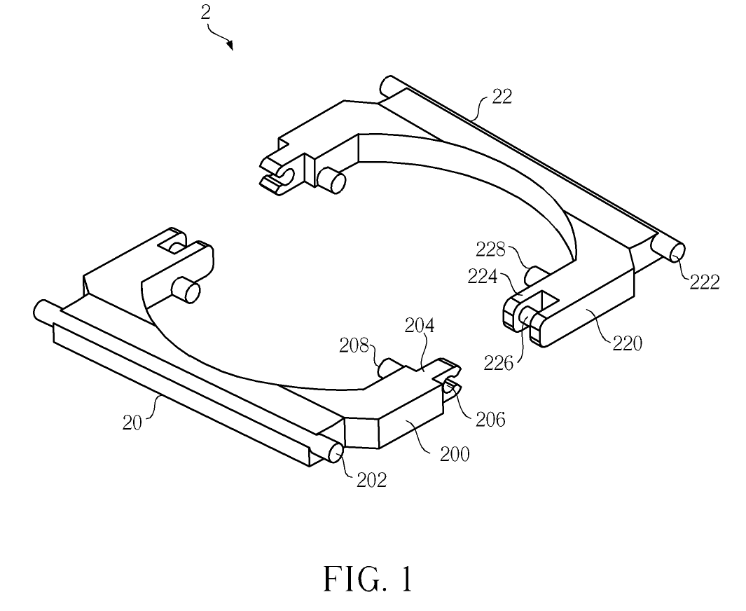

Referring to FIG. 1, FIG. 1 is a schematic diagram illustrating a supporting structure 2 according to a first embodiment of the invention. As shown in FIG. 1, the supporting structure 2 is used to support a keycap (not shown) . The supporting structure 2 comprises a first supporting member 20 and a second supporting member 22.

A first connecting part 202 and a second connecting part 204 are disposed at both ends of a first arm 200 of the first supporting member 20 respectively. The first connecting part 202 is movably connected to the key cap. A C-shaped hole 206 is formed on the second connecting part 204.

A third connecting part 222 and a fourth connecting part 224 are disposed at both ends of a second arm 220 of the second supporting member 22 respectively. The third connecting part 222 is movably connected to the key cap and opposite to the first connecting part 202. A shaft 226 is disposed on the fourth connecting part 224. The shaft 226 is embedded into the C-shaped hole 206 via an opening of the C-shaped hole 206, such that the first supporting member 20 and the second supporting member 22 are capable of rotating relative to each other.

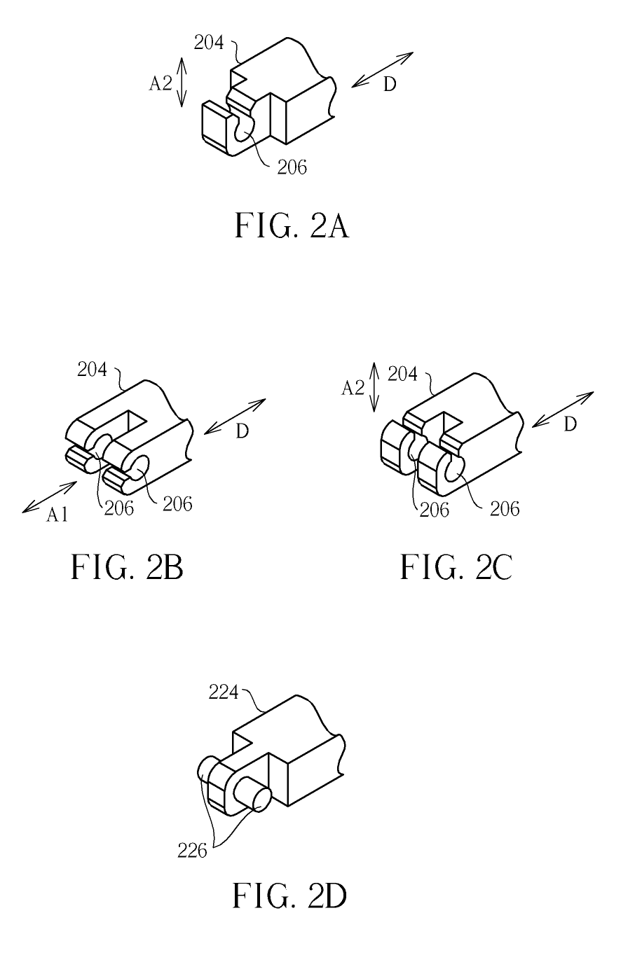

It should be noted that the second connecting part 204 can be different types shown in FIG. 2A through FIG. 2C, but not limited to the types shown in those figures. Besides, as shown in FIG. 2B and 2C, two C-shaped holes 206 are formed on the second connecting part 204, so as to reinforce the engagement of the supporting structure 2. It should be noted that the number of C-shaped holes 206 is not limited to one or two, and there may be more than two C-shaped holes 206 formed on the second connecting part 204. As shown in FIG. 2B, an opening direction A1 of the C-shaped hole 206 of the second connecting part 204 is parallel to an axial direction D of the first arm 200. As shown in FIG. 2A and FIG. 2C, an opening direction A2 of the C-shaped hole 206 of the second connecting part 204 is perpendicular to an axial direction D of the first arm 200.

Since there may be two or more than two C-shaped holes 206 formed on the second connecting part 204, two or more than two shafts 226 have to be formed on the fourth connecting part 224 correspondingly, as shown in FIG. 2D.

The first connecting part 202 and the second connecting part 222 can be slidably and pivotally connected to the key cap when the first supporting member 20 and the second supporting member 22 are assembled to form the supporting structure 2. In practical application, the first supporting member 20 and the second supporting member 22 can be U-shaped. Accordingly, the first supporting member 20 comprises two first arms 200, and the second supporting member 22 comprises two second arms 220 as well. Similarly, each of the two second connecting parts 204 of the first supporting member 20 can have the C-shaped hole 206 or the shaft 226, and each of the two fourth connecting parts 224 of the second supporting member 22 can have the C-shaped hole 206 or the shaft 226 correspondingly. It should be noted that it is necessary for the second connecting part 204 and the fourth connecting part 224 to have corresponding structure, i.e. a combination of the C-shaped hole 206 and the shaft 226.

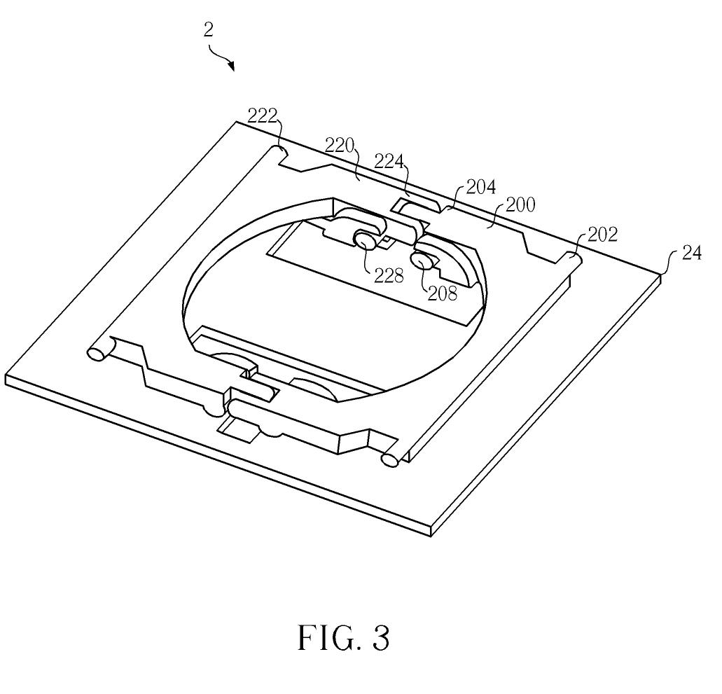

Referring to FIG. 3, FIG. 3 is a schematic diagram illustrating the supporting structure 2 disposed on a base 24. As shown in FIG. 3, a first protruding shaft 208 is disposed on the first arm 200 and adjacent to the second connecting part 204. A second protruding shaft 228 is disposed on the second arm 220 and adjacent to the fourth connecting part 224. The first protruding shaft 208 and the second protruding shaft 228 are movably and pivotally connected to the base 24, such that the first arm 200 and the second arm 220 are capable of moving relative to the base 24.

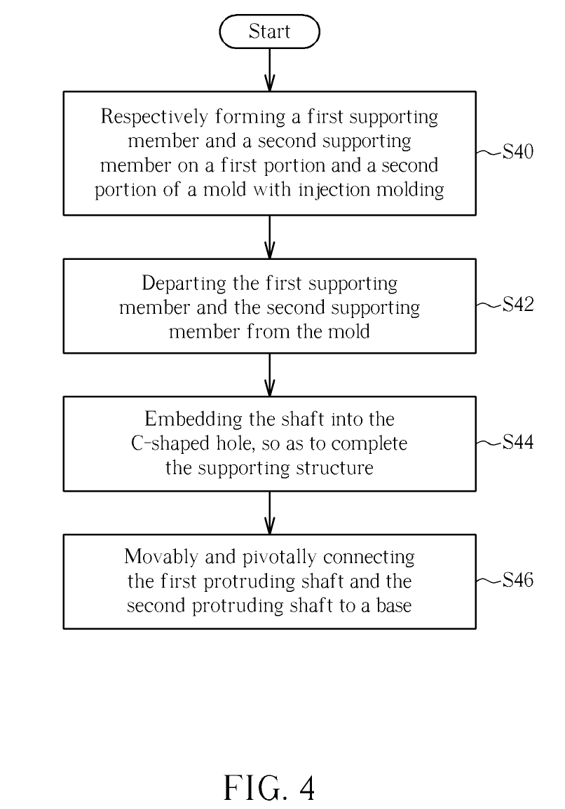

Referring to FIG. 4 and FIG. 5, FIG. 4 is a flow chart illustrating a method for manufacturing the supporting structure 2 according to a second embodiment of the invention, and FIG. 5 is a schematic diagram illustrating two first supporting members 20 formed on a first portion 30 and two second supporting members 22 formed on a second portion 32.

As shown in FIG. 4, first of all, step S40 is executed to respectively forma first supporting member 20 and a second supporting member 22 on a first portion 30 and a second portion 32 of a mold with injection molding. The first supporting member 20 has a first arm 200, a first connecting part 202 and a second connecting part 204 are disposed at both ends of the first arm 200 respectively, the first connecting part 202 can be movably connected to a key cap (not shown), and a C-shaped hole 206 is formed on the second connecting part 204. The second supporting member 22 has a second arm 220, a third connecting part 222 and a fourth connecting part 224 are disposed at both ends of the second arm 220 respectively, the third connecting part 222 can be movably connected to the key cap and is opposite to the first connecting part 202, and a shaft 226 is disposed on the fourth connecting part 224. The first supporting member 20 and the second supporting member 22 are formed in the mold correspondingly, as shown in FIG. 5. In practical application, a plurality of first supporting members 20 can be formed on the first portion 30, and a plurality of second supporting members 22 can be formed on the second portion 32.

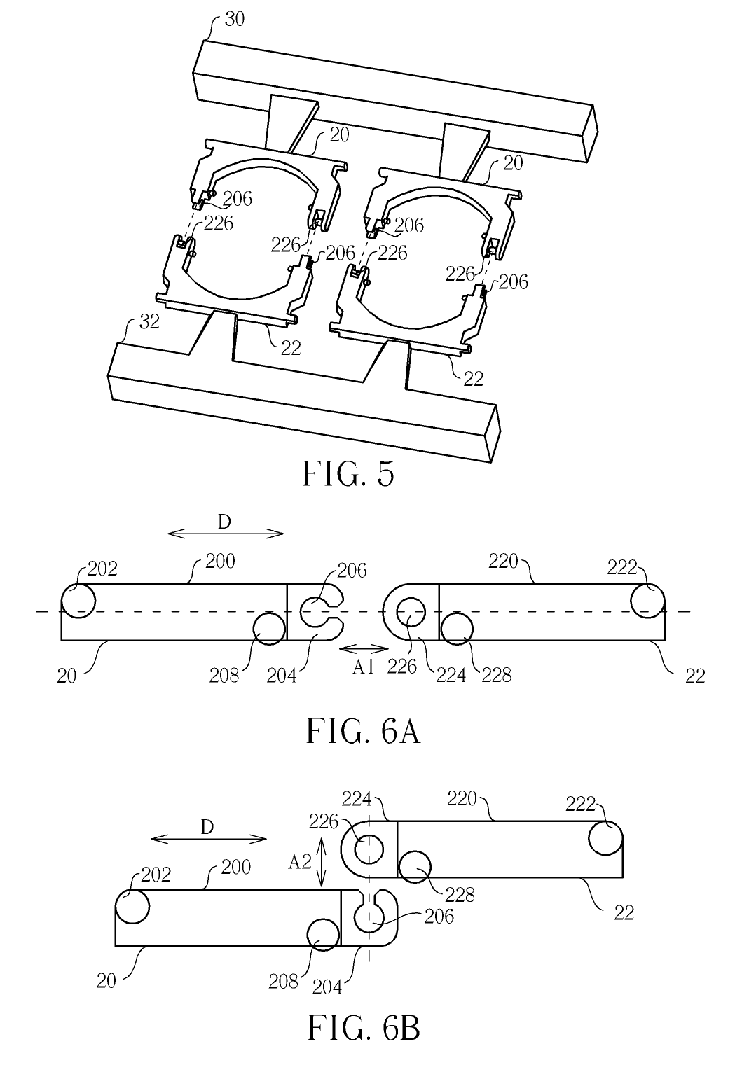

Afterward, step S42 is executed to depart the first supporting member 20 and the second supporting member 22 from the mold. Then, step S44 is executed to embed the shaft 226 into the C-shaped hole 206, such that the first supporting member 20 and the second supporting member 22 are capable of rotating relative to each other, so as to complete the supporting structure 2. In practical application, if an opening direction A1 of the C-shaped hole 206 is parallel to an axial direction D of the first arm 200, the shaft 226 has to be embedded into the C-shaped hole 206 along a direction parallel to the axial direction D, as shown in FIG. 6A. On the other hand, if an opening direction A2 of the C-shaped hole 206 is perpendicular to an axial direction D of the first arm 200, the shaft 226 has to be embedded into the C-shaped hole 206 along a direction perpendicular to the axial direction D, as shown in FIG. 6B.

Finally, step S46 is executed to movably and pivotally connect the first protruding shaft 208 and the second protruding shaft 228 to a base 24, such that the first arm 200 and the second arm 220 are capable of moving relative to the base 24.

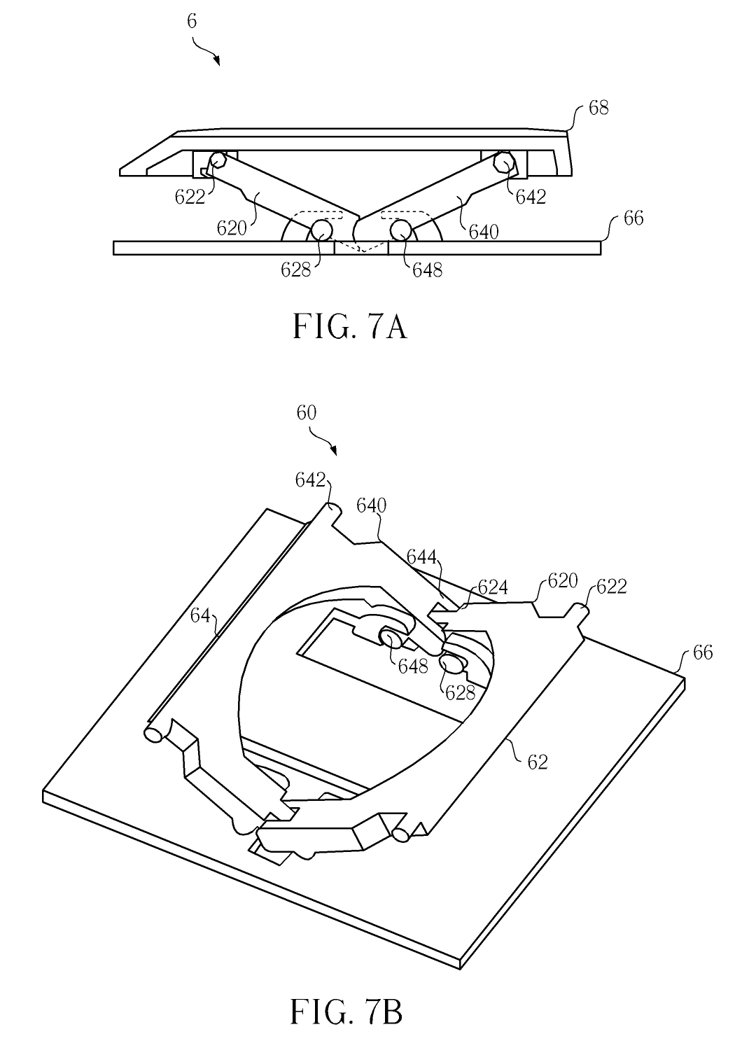

Referring to FIG. 7A and FIG. 7B, FIG. 7A is a sectional diagram illustrating a keyswitch 6 according to a third embodiment of the invention, and FIG. 7B is a schematic diagram illustrating a supporting structure 60 disposed on a base 66 of FIG. 7A. As shown in FIG. 7A and FIG. 7B, the keyswitch 6 comprises the base 66, a key cap 68 and the supporting structure 60. The supporting structure 60 comprises a first supporting member 62 and a second supporting member 64. A first arm 620, a first connecting part 622, a second connecting part 624, a C-shaped hole (not shown) and a first protruding shaft 628 of the first supporting member 62, and a second arm 640, a third connecting part 642, a fourth connecting part 644, a shaft (not shown) and a second protruding shaft 648 of the second supporting member 64 are equivalent to the embodiments mentioned above, so those will not be depicted herein. In practical application, the supporting structure 60 moves downward only when the key cap 68 is pressed by a force, otherwise the supporting structure 60 supports the key cap 68 to be at a fixed height stably.

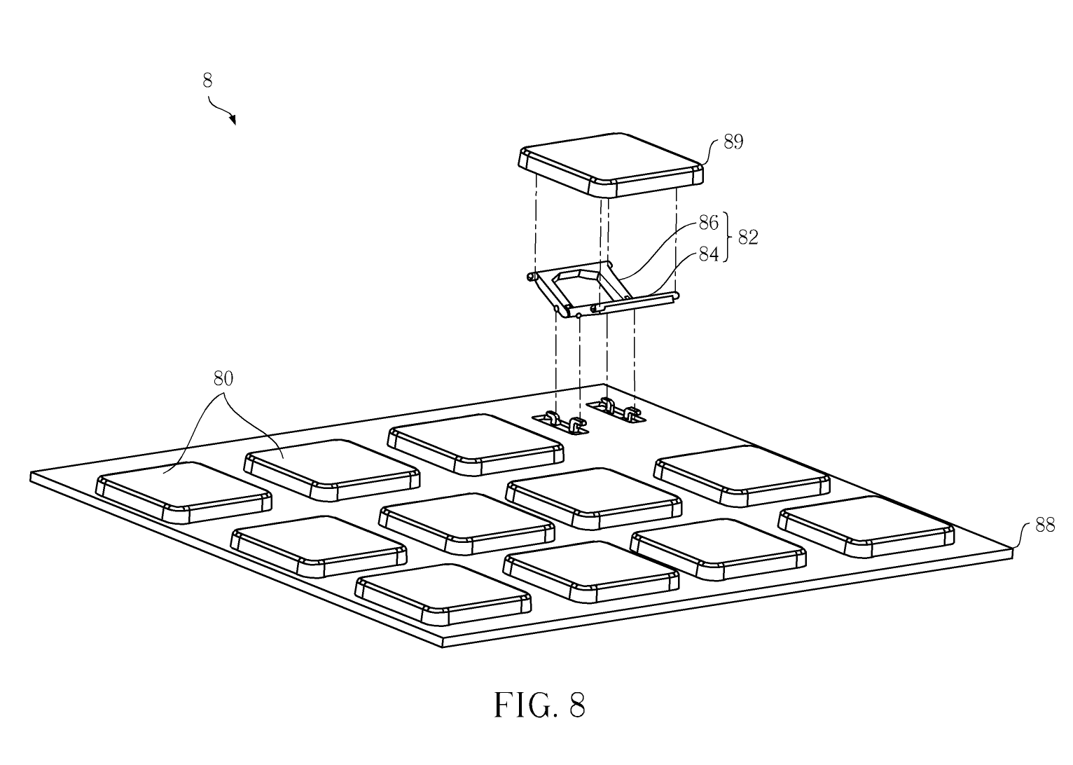

Referring to FIG. 8, FIG. 8 is a schematic diagram illustrating a keyboard 8 according to a fourth embodiment of the invention. As shown in FIG. 8, the keyboard 8 comprises a base 88, a plurality of key caps 89 and a plurality of supporting structures 82. All the components of each keyswitch 80 are equivalent to the embodiments mentioned above, so those will not be depicted herein. In practical application, the supporting structure 82 (including the first supporting member 84 and the second supporting member 86) can be manufactured according to a size of each keyswitch 80 of the keyboard 8, and the supporting structure 82 can be manufactured rapidly and cheaply according to the invention, so as to lower production cost of the keyboard 8 and increase production efficiency.

Compared to the prior art, after the supporting structure of the invention is formed in the injection mold, an operator only has to embed the shaft of one supporting member into the C-shaped hole of another supporting member via the opening of the C-shaped hole, and then takes the plurality of supporting structures out, so as to complete the supporting structure. The supporting structure of the invention can be assembled automatically due to the improved engagement of the supporting structure, so as to decrease manpower in assembling and lower production cost, such that cost for manufacturing keyswitch or keyboard can be lowered as well.

Those skilled in the art will readily observe that numerous modifications and alterations of the device and method may be made while retaining the teachings of the invention.

What is claimed is:

1. A supporting structure for supporting a key cap, the supporting structure comprising:
a first supporting member, a first connecting part and a second connecting part being disposed at both ends of a first arm of the first supporting member respectively, the first connecting part being movably connected to the key cap, a C-shaped hole being formed on the second connecting part; and
a second supporting member, a third connecting part and a fourth connecting part being disposed at both ends of a second arm of the second supporting member respectively, the third connecting part being movably connected to the key cap and opposite to the first connecting part, a shaft being disposed on the fourth connecting part, the shaft being embedded into the C-shaped hole via an opening of the C-shaped hole, such that the first supporting member and the second supporting member are capable of rotating relative to each other.

2. The supporting structure of claim 1, wherein a first protruding shaft is disposed on the first arm and adjacent to the second connecting part, a second protruding shaft is disposed on the second arm and adjacent to the fourth connecting part, the first protruding shaft and the second protruding shaft are movably and pivotally connected to a base, such that the first arm and the second arm are capable of moving relative to the base.

3. The supporting structure of claim 1, wherein the first supporting member and the second supporting member are U-shaped.

4. The supporting structure of claim 1, wherein the first connecting part and the third connecting part are slidably and pivotally connected to the key cap.

5. The supporting structure of claim 1, wherein an opening direction of the C-shaped hole is parallel to an axial direction of the first arm, such that the shaft is embedded into the C-shaped hole along a direction parallel to the axial direction.

6. The supporting structure of claim 1, wherein an opening direction of the C-shaped hole is perpendicular to an axial direction of the first arm, such that the shaft is embedded into the C-shaped hole along a direction perpendicular to the axial direction.

7. A method for manufacturing a supporting structure for supporting a key cap, the method comprising steps of:
respectively forming a first supporting member and a second supporting member on a first portion and a second portion of a mold with injection molding, wherein the first supporting member has a first arm, a first connecting part and a second connecting part are disposed at both ends of the first arm respectively, the first connecting part is movably connected to the key cap, and a C-shaped hole is formed on the second connecting part; wherein the second supporting member has a second arm, a third connecting part and a fourth connecting part are disposed at both ends of the second arm respectively, the third connecting part is movably connected to the key cap and opposite to the first connecting part, a shaft is disposed on the fourth connecting part, wherein the first supporting member and the second supporting member are formed in the mold correspondingly;
departing the first supporting member and the second supporting member from the mold; and
embedding the shaft into the C-shaped hole, such that the first supporting member and the second supporting member are capable of rotating relative to each other, so as to complete the supporting structure.

8. The method of claim 7, wherein the first supporting member and the second supporting member are U-shaped.

9. The method of claim 7, wherein the first connecting part and the third connecting part are slidably and pivotally connected to the key cap.

10. The method of claim 7, wherein an opening direction of the C-shaped hole is parallel to an axial direction of the first arm, such that the shaft is embedded into the C-shaped hole along a direction parallel to the axial direction.

11. The method of claim 7, wherein an opening direction of the C-shaped hole is perpendicular to an axial direction of the first arm, such that the shaft is embedded into the C-shaped hole along a direction perpendicular to the axial direction.

12. The method of claim 7, wherein a first protruding shaft is disposed on the first arm and adjacent to the second connecting part, a second protruding shaft is disposed on the second arm and adjacent to the fourth connecting part, the method further comprising step of :
movably and pivotally connecting the first protruding shaft and the second protruding shaft to a base, such that the first arm and the second arm are capable of moving relative to the base.

13. A keyboard comprising:
a base;
a plurality of key caps; and
a plurality of supporting structures disposed between the key caps and the base for supporting the key caps, each of the supporting structures comprising:
a first supporting member, a first connecting part and a second connecting part being disposed at both ends of a first arm of the first supporting member respectively, the first connecting part being movably connected to the key cap, a C-shaped hole being formed on the second connecting part; and
a second supporting member, a third connecting part and a fourth connecting part being disposed at both ends of a second arm of the second supporting member respectively, the third connecting part being movably connected to the key cap and opposite to the first connecting part, a shaft being disposed on the fourth connecting part, the shaft being embedded into the C-shaped hole via an opening of the C-shaped hole, such that the first supporting member and the second supporting member are capable of rotating relative to each other.

14. The keyboard of claim 13, wherein a first protruding shaft is disposed on the first arm and adjacent to the second connecting part, a second protruding shaft is disposed on the second arm and adjacent to the fourth connecting part, the first protruding shaft and the second protruding shaft are movably and pivotally connected to the base, such that the first arm and the second arm are capable of moving relative to the base.

15. The keyboard of claim 13, wherein the first supporting member and the second supporting member are U-shaped.

16. The keyboard of claim 13, wherein the first connecting part and the third connecting part are slidably and pivotally connected to the key cap.

17. The keyboard of claim 13, wherein an opening direction of the C-shaped hole is parallel to an axial direction of the first arm, such that the shaft is embedded into the C-shaped hole along a direction parallel to the axial direction.

18. The keyboard of claim 13, wherein an opening direction of the C-shaped hole is perpendicular to an axial direction of the first arm, such that the shaft is embedded into the C-shaped hole along a direction perpendicular to the axial direction.
